(19) United States
(12) Patent Application Publication
(10) Pub. No.: US 2022/0163339 A1
(43) Pub. Date: May 26, 2022

(54) DEVICE AND METHOD FOR CONTROLLING TRAVEL OF VEHICLE

(71) Applicants: Hyundai Motor Company, Seoul (KR); Kia Corporation, Seoul (KR)

(72) Inventor: Sang Woo Lee, Seoul (KR)

(21) Appl. No.: 17/474,365

(22) Filed: Sep. 14, 2021

(30) Foreign Application Priority Data
Nov. 26, 2020 (KR) 10-2020-0161686

(51) Int. Cl. G01C 21/34; G08G 1/0968; G01C 21/36

(52) U.S. Cl. CPC G01C 21/3492; G01C 21/3691; G08G 1/096833

(57) ABSTRACT

A device for controlling travel of a vehicle includes an antenna for receiving a global positioning system (GPS) signal, a processor that identifies the signal received through the antenna to calculate coordinates of a location and a speed of the vehicle, and a display device that provides the calculated result, where the processor stores an estimated time of arrival (ETA) provided when searching for a center route, stores a time of arrival when arriving at a destination, compares the estimated time of arrival with the time of arrival, performs correction on traffic information in consideration of the comparison result, and provides an estimated time of arrival (ETA) specialized for each driver.

### CROSS-REFERENCE TO RELATED APPLICATION

This application claims under 35 U.S.C. § 119(a) the benefit of Korean Patent Application No. 10-2020-0161686, filed in the Korean Intellectual Property Office on Nov. 26, 2020, the entire contents of which are incorporated herein by reference.

### BACKGROUND

### (a) Technical Field

The present disclosure relates to a device and a method for controlling travel of a vehicle, more particularly, to the device and method for controlling the travel of the vehicle capable of controlling correction and collection of traffic information of the vehicle.

### (b) Description of the Related Art

A scheme of collecting traffic information by generating a speed by calculating a road passing time through locations and coordinates of a vehicle every second using GPS information of the vehicle, or calculating an estimated time of arrival by summing all link times of a route by calculating an estimated passing time using traffic information for each link has been applied to existing traffic information collection and estimated time of arrival calculation.

Such traffic information collection and estimated time of arrival calculation has a disadvantage of being not easy to be distinguished for each individual because all traffic information is collected in a form of simple GPS information collection.

That is, even though vehicle users have different driving habits and there are various schemes for dealing with traffic flow, it is difficult to infer driving habits of individual drivers without consideration of such factors, and correction and filtering of information based on a vehicle is impossible in generation of the traffic information.

Therefore, there is a need for a method for generating the traffic information which is more accurate and into which user characteristics re considered, and for correcting and collecting the traffic information therethrough.

### SUMMARY

An aspect of the present disclosure provides a device for correcting and collecting traffic information in a vehicle travel system, a system including the same, and a method for correcting and collecting the traffic information.

Another aspect of the present disclosure provides a device for controlling travel, a system including the same, and a method for controlling the travel in consideration of driving characteristics of each driver in a vehicle travel system.

Another aspect of the present disclosure provides a device for controlling travel, a system including the same, and a method for controlling the travel in which filtering provides corrected traffic information in a vehicle travel system.

Another aspect of the present disclosure provides a device for controlling travel, a system including the same, and a method for controlling the travel in which a weight is applied in a vehicle travel system.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a method for controlling traveling of a vehicle includes storing an estimated time of arrival (ETA) provided when searching for a center route, storing a time of arrival when arriving at a destination, comparing the estimated time of arrival with the time of arrival, performing correction on traffic information in consideration of the comparison result, and providing an estimated time of arrival (ETA) specialized for each driver.

In one implementation, the performing of the correction on the traffic information may include determining whether there is an increase or decrease of the ETA in a traffic information section for each line equal to or more than a predetermined reference time.

In one implementation, the performing of the correction on the traffic information may include comparing the provided ETA with the time of arrival to determine whether a driver of the vehicle has a travel speed higher than or lower than a travel speed of another driver.

In one implementation, the performing of the correction on the traffic information may include filtering the corresponding traffic information in consideration of the determining of whether the driver of the vehicle has the travel speed higher than or lower than the travel speed of another driver.

In one implementation, the filtering of the traffic information may include excluding abnormal travel of the driver, or identifying and excluding abnormality in the traffic information not accurately reflected even though a corresponding traffic information section is actually congested.

In one implementation, the performing of the correction on the traffic information may include comparing the provided ETA with the time of arrival, and applying a weight to the traffic information.

In one implementation, the performing of the correction on the traffic information may include comparing the ETA with an actual travel time, and determining whether a difference between the ETA and the actual travel time is within a predetermined time range.

In one implementation, the performing of the correction on the traffic information may include applying, when (ETA-actual travel time) is positive, a weight to the traffic information to lower a value of the traffic information by a corresponding %, and applying, when the (ETA-actual travel time) is negative, the weight to the traffic information to increase the value of the traffic information by a corresponding %.

In one implementation, the providing of the estimated time of arrival (ETA) specialized for each driver may include storing an individual correction history for each driver.

In one implementation, the providing of the estimated time of arrival (ETA) specialized for each driver may include determining whether the number of individual correction histories exceeds a predetermined number of times N, calculating an individual correction factor(x) for the number of times, updating the individual correction factor(x) in units of N cases, and providing a corrected ETA using the updated individual correction factor.

According to another aspect of the present disclosure, a device for controlling traveling of a vehicle includes an antenna for receiving a global positioning system (GPS) signal, a processor that identifies the signal received through the antenna to calculate coordinates of a location and a speed of the vehicle, and a display device that provides the calculated result, and the processor stores an estimated time of arrival (ETA) provided when searching for a center route, stores a time of arrival when arriving at a destination, compares the estimated time of arrival with the time of arrival, performs correction on traffic information in consideration of the comparison result, and provides an estimated time of arrival (ETA) specialized for each driver.

In one implementation, the processor may determine whether there is an increase or decrease of the ETA in a traffic information section for each line equal to or more than a predetermined reference time.

In one implementation, the processor may compare the provided ETA with the time of arrival to determine whether a driver of the vehicle has a travel speed higher than or lower than a travel speed of another driver.

In one implementation, the processor may determine whether to filter the traffic information in consideration of the determination of whether the driver of the vehicle has the travel speed higher than or lower than the travel speed of another driver.

In one implementation, the processor may exclude abnormal travel of the driver, or identify and filter abnormality in the traffic information not accurately reflected even though a corresponding traffic information section is actually congested.

In one implementation, the processor may compare the provided ETA with the time of arrival, and apply a weight to the traffic information.

In one implementation, the processor may compare the ETA with an actual travel time, and determine whether a difference between the ETA and the actual travel time is within a predetermined time range.

In one implementation, the processor may apply, when (ETA-actual travel time) is positive, a weight to the traffic information to lower a value of the traffic information by a corresponding %, and apply, when the (ETA-actual travel time) is negative, the weight to the traffic information to increase the value of the traffic information by a corresponding %.

In one implementation, the processor may control to store an individual correction history for each driver in storage.

In one implementation, the processor may determine whether the number of individual correction histories exceeds a predetermined number of times N, calculate an individual correction factor(x) for the number of times, update the individual correction factor(x) in units of N cases, and perform calculation to provide a corrected ETA using the updated individual correction factor.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a vehicle system including a vehicle control device according to an embodiment of the present disclosure;

FIG. 2 is a diagram illustrating an operation of a vehicle for collecting traffic information and providing an estimated time of arrival according to an embodiment of the present disclosure;

FIG. 3 is a diagram illustrating a process of correcting and filtering traffic information according to an embodiment of the present disclosure;

FIG. 4 is a diagram illustrating an operation of providing an ETA for each individual according to an embodiment of the present disclosure; and

FIG. 5 is a diagram illustrating an operation of a vehicle of correcting a probe that generates an error in traffic information according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

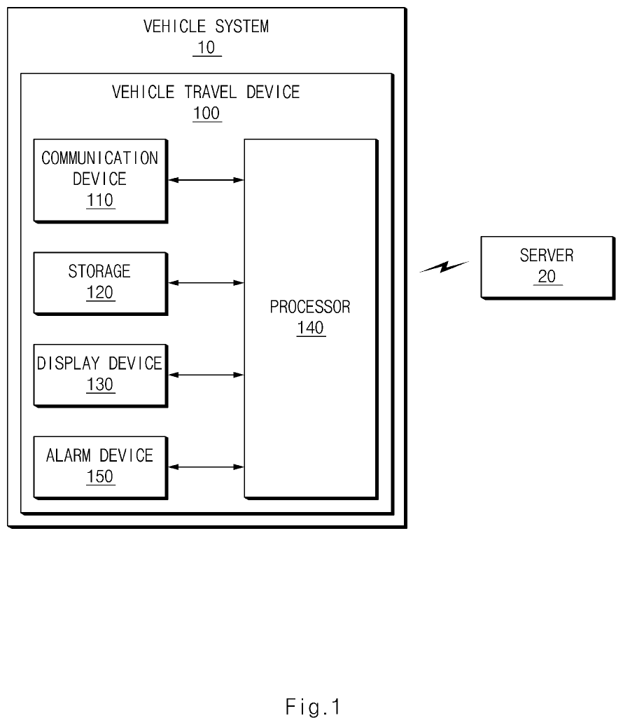

Hereinafter, embodiments of the present disclosure will be described in detail with reference to FIGS. 1 to 6.

FIG. 1 is a block diagram illustrating a configuration of a vehicle system including a vehicle travel device according to an embodiment of the present disclosure.

Referring to FIG. 1, a vehicle travel device 100 according to an embodiment of the present disclosure may include a communication device 110, storage 120, a display device 130, a processor 140, and an alarm device 150.

The communication device 110 is a hardware device implemented with various electronic circuits to transmit and receive a signal through a wireless or wired connection. In the present disclosure, the communication device 110 performs in-vehicle communication through CAN communication, CAN-FD communication, LIN communication, Ethernet communication, and the like. The communication device 110 may include various communication units such as a mobile communication unit, a broadcast receiving unit such as a DMB module or a DVB-H module, a short-range communication unit such as a Zigbee module, which is a Bluetooth module, or a NFC module, a Wi-Fi communication unit, and the like for communication with a server 20 outside a vehicle, an external diagnostic device, and the like. In this connection, the controller area network (CAN) communication is a network system for the vehicle developed to provide digital serial communication between various measurement control equipment in the vehicle, and a CAN-data bus is used for data transmission and control between ECUs.

The communication device 110 according to the present disclosure may perform communication in both directions between the vehicle and a surrounding vehicle, between the vehicle and road infrastructure, and between the vehicle and a pedestrian, and continuously share, transmit, and receive data with all elements including a host vehicle and the surrounding vehicle. The communication device 110 may be in a form of being mounted on the vehicle or in a form of being in contact with a V2X communication terminal. Thus, inter-vehicle communication and inter-vehicle infrastructure communication are possible, and the vehicle is able to perform autonomous driving by itself to a predetermined destination through a vehicle sensor and a travel control function of the vehicle. In this connection, the vehicle sensor may include at least one of a global positioning system (GPS) sensor, a gyro sensor, and/or an acceleration sensor. In addition, the communication device 110 may perform communication with a communication system for supporting an autonomous driving service in connection with infrastructure information added through a V2X communication function.

The communication device 110 therefor may support a WAVE communication technology for the V2X communication function, or may support a communication technology of a 3GPP-based LTE/NR system. For reference, a wireless access for vehicle environment (WAVE) communication, which is a technology modified from a technology of an IEEE 802.11a wireless LAN, has characteristics that a 5.9 GHz dedicated band is used, a channel frequency bandwidth is 10 MHz, a maximum data speed is 27 Mbps, wireless channel access is in a CSMA/CA scheme, and the WAVE communication is composed of an IEEE 802.11p physical layer and a 1609 communication stack.

In one example, when supporting the 3GPP system, the communication device 110 may include LTE eV2X and 5G V2X communication technologies based on LTE V2X (Rel. 14). V2X communication includes vehicle-to-vehicle (V2V), which means LTE/NR-based communication between vehicles, vehicle-to-pedestrian (V2P), which means LTE/NR-based communication between a vehicle and a terminal carried by an individual, and vehicle-to-infrastructure/network (V2I/N), which means LTE/NR-based communication between a vehicle and road-side unit/network. The V2X communication has characteristics of improving network scalability in the V2I communication using OFDMA wireless access. That is, the V2X communication has an advantage of extending a cell coverage through the 3GPP network system. In addition, there is no limitation on a multiple access technique of a wireless communication system to which the present disclosure is applied. For example, various multiple access techniques such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, and OFDM-CDMA may be used. In addition, a time division duplex (TDD) scheme of transmission using different times or a frequency division duplex (FDD) scheme of transmission using different frequencies may be used for uplink transmission and downlink transmission.

The storage 120 may store downloaded data such as vehicle information, communication information, and the like received from the server 20 through the communication device 110. Accordingly, the storage 120 may store/manage/update location information of the host vehicle, road information, information on a region around a road such as a bus stop, and information on a road environment through the vehicle sensors mounted in the vehicle and the server 20. In addition, the storage 120 may store information on a destination set by a user, existing searched route information, and the like. In addition, according to the present disclosure, the storage 120 may receive each communication system information for the V2X communication through a communication server and store/manage/update the communication system information. Alternatively, the storage 120 may store/manage data through a server supporting data for various input sensors, the road information, the communication information, and the like for supporting the autonomous driving. In addition, the storage 120 may store communication information and V2I/N information for a V2X service. In addition, the storage 120 may store at least one of a network load, a vehicle power state, a battery state, and/or an estimated remaining ROM data transmission time determined by the processor 140.

The storage 120 may include at least one type of storage media such as a memory such as a flash memory type, a hard disk type, a micro type, a card type (e.g., a secure digital card (SD card) or an eXtream digital card (XD card)), and the like, and/or a memory such as a random access memory (RAM), a static RAM (SRAM), a read-only memory (ROM), a programmable ROM (PROM), an electrically erasable PROM (EEPROM), a magnetic RAM (MRAM), a magnetic disk, and an optical disk type.

The display device 130 may be controlled by the processor 140 to display a screen for receiving user authentication approval for wireless update of the vehicle. The display device 130 may be implemented as a head-up display (HUD), a cluster, an audio video navigation (AVN), and the like. In addition, the display device 130 may include at least one of a liquid crystal display (LCD), a thin film transistor-LCD (IFT LCD), a light emitting diode (LED) display, an organic LED (OLED) display, an active matrix OLED (AMOLED) display, a flexible display, a bended display, and/or a three-dimensional display (3D display). Some of those displays may be implemented as a transparent display in a transparent type or a semi-transparent type such that the outside may be seen. In addition, the display device 130 may be embodied as a touchscreen including a touch panel and used as an input device in addition to an output device.

The alarm device 150 may provide user-required-information on the screen for receiving the approval from the user and an operation of a sunroof, and may output a notification for the approval to the user when displaying the user-required-information on the display device 130.

The processor 140 may be electrically connected to the communication device 110, the storage 120, the display device 130, the alarm device 150, and the like, may electrically control each component, and may be an electric circuit that executes a command of software, thereby performing various data processing and calculations to be described later. According to an example of the present disclosure, the processor 140 may control to recognize information on a surrounding region for predicting an object around the vehicle/a road condition, and a congestion degree through the vehicle sensors located at front and rear portions of the vehicle, identify a route congestion degree of the vehicle predicted through the vehicle sensor and an external server, and control a weight for each driver and probe subsequent processing of traffic information.

In particular, according to an example of the present disclosure, the processor 140 stores an estimated time of arrival provided when searching for a center route, then stores a destination arrival time when arriving at a destination (when a trajectory is terminated), then compares the estimated time of arrival with the destination arrival time, and then performs correction/filtering of the traffic information. In this connection, the comparison result is applied to the corresponding vehicle to provide an individual-specific estimated time of arrival. In this connection, an operation of calculating a predicted time by reflecting driving characteristics of the driver, that is, applying the weight disclosed in the present disclosure when predicting the ETA is included.

The processor according to the present disclosure may divide a case in which an increase or decrease of the ETA in a traffic information section for each line is equal to or more than 5 minutes into a case of passing quickly and a case of passing slowly. In addition, the processor may determine that the driver has performed abnormal travel such as lane offense and the like in the case of passing quickly, and determine that a congestion in the corresponding section is severe and the corresponding traffic information is not properly reflected in the case of passing slowly. Accordingly, the processor performs filtering for the corresponding two cases to perform processing to generate the traffic information. In addition, the processor according to the present disclosure calculates a difference between the actually provided ETA and an actual travel time and applies the difference to traffic information of each vehicle to generate corrected traffic information.

As described above, the processor 140 of the present disclosure supports a global positioning system (GPS). In addition, a GPS receiver and an antenna (implemented through the communication device) that receive a GPS, a processing device that processes the received signal and calculates coordinates of a location, a speed vector, and the like of a receiver (the vehicle), the output device that outputs the calculated result, and the like control the operation. In addition, the vehicle to everything (V2X) (a communication system between the vehicle and the object) is able to be supported. In addition, various traffic⋅road situation⋅vehicle⋅ pedestrian information may be exchanged and shared through wireless communication centering on the vehicle such as the vehicle to infra (V2I), the vehicle to vehicle (V2V), the vehicle to pedestrian (V2P), and the like. Accordingly, the vehicle system according to the present disclosure supports an evolved communication system of LTE/LTE-A/NR/5G, and the communication system is able to be supported by being mounted on the vehicle through the antenna disposed in the vehicle or a mobile phone and a smart device of each driver. The processor may control functions of a radar, the sensor, and a camera mounted in the vehicle to control the travel of the vehicle, and also more efficiently identify collection/acquisition of the traffic information and the vehicle information by recognizing the surrounding region 360° around the vehicle. In particular, because of a development of a V2X communication service for a smart transportation service, the vehicle system according to the present disclosure supports an intelligent transport system (ITS) service, which is connected to a smart car, the infrastructure, a back-end server, and the like based on wired and wireless networks to share information through data exchange, secure safety, improve a traffic efficiency, and provide user convenience. To this end, various services such as the traffic information, map information, and the like are provided to the user as well as travel and brake, which are basic control functions of the vehicle based on communication inside the system through a communication ECU. The smart devices are connected to each other through various wireless network systems to provide the V2X service such as real-time road information, vehicle remote control, and the like.

Accordingly, the processor may control the communication ECUs that process V2X communication signals of various wired/wireless communication, the global positioning system (GPS), a telematics, a WIFI, and a GPP system, and an application processor (AP) ECUs that process application data based on each system.

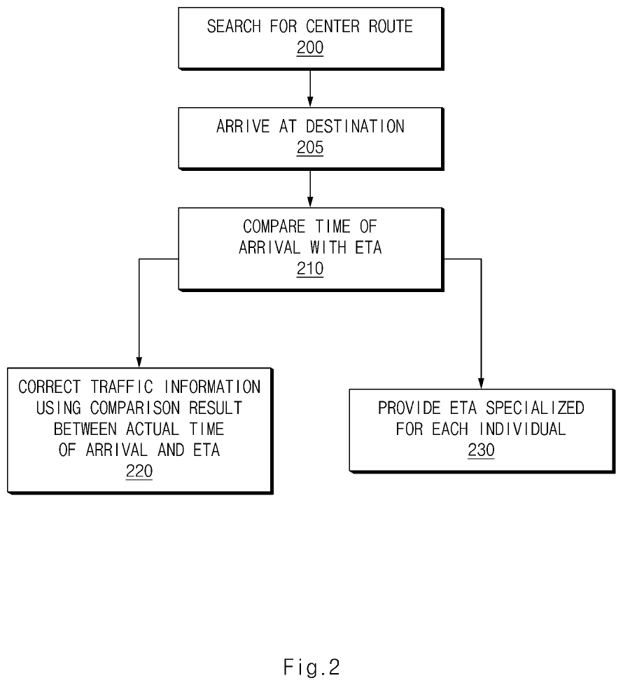

Hereinafter, the filtering and the generation of the traffic information in consideration of the driver characteristics according to an embodiment of the present disclosure will be described in detail with reference to FIGS. 2 to 5.

FIG. 2 is a diagram illustrating an operation of a vehicle for collecting traffic information and providing an estimated time of arrival according to an embodiment of the present disclosure.

Referring to FIG. 2, first, only a vehicle that has performed the center route search is targeted. In addition, a deviated re-searched vehicle is applied in consideration of a following situation. As an example, re-search of deviation within a vicinity (Ex. 800 m) of a departure point is included, and an ETA after the deviation is used. In addition, re-search of deviation within a vicinity (Ex. 800 m) of a destination is included, and an ETA before the deviation is used. In addition, re-search of deviation during the travel is calculated using the travel trajectory.

The vehicle system to which the present disclosure is applied stores the estimated time of arrival provided when searching for the center route (200). When arriving at the destination (when the trajectory is terminated), the corresponding time is stored (205), then the estimated time of arrival (ETA) and the destination arrival time are compared with each other (210), and then the correction/filtering of the traffic information is performed (220). In this connection, the comparison result is applied to the corresponding vehicle to provide the ETA specialized for each individual (230).

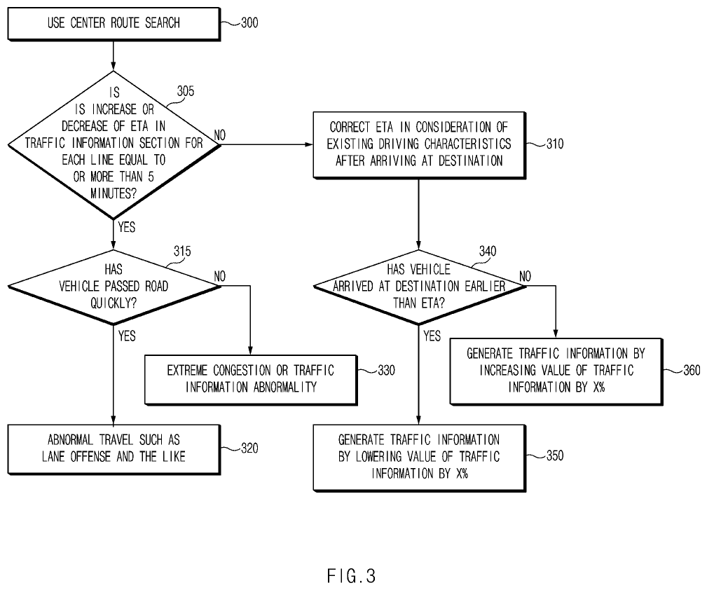

FIG. 3 is a diagram illustrating a process of correcting and filtering traffic information by determining whether a driver is faster or slower than a regular driver by comparing an arrival time with an ETA provided according to an embodiment of the present disclosure.

Referring to FIG. 3, the correction and the filtering of the traffic information uses the center route search, and targets a vehicle that has normally traveled without being deviated (300). In this connection, filter logic performs following determination. Whether the increase or decrease of the ETA in the traffic information section for each line is equal to or more than 5 minutes is determined (305). As an example, when it is determined that the increase or decrease of the ETA is equal to or more than 5 minutes and the vehicle has passed the road quickly (315), it is determined that the abnormal travel such as the lane offense has occurred to the corresponding vehicle during the travel (320). In one example, when it is determined that the increase or decrease of the ETA is equal to or more than 5 minutes and the vehicle has passed the road slowly rather than quickly (330), it is determined that there is a possibility that the congestion is severe in the travel section of the corresponding vehicle and the traffic information is not properly reflected (330). When it is determined to be the above two cases, separate processing such as performing the filtering operation when generating the traffic information after subsequent verification is possible. That is, the abnormal travel of the driver may be filtered for error correction of the corresponding section by sensing a portion with a large error in the section. This means that the filtering is possible for a section in which the line offense or the abnormal driving was performed.

In one example, correction logic performs following determination. The difference between the provided ETA and the actual travel time is calculated and applied to the traffic information of each vehicle to generate the corrected traffic information. As an example, whether the increase or decrease of the ETA in the traffic information section for each line is equal to or more than 5 minutes is determined (305). After the arrival at the destination, the correction of the ETA is performed in consideration of reference driving characteristics (310). In this connection, whether the vehicle has arrived at the destination earlier than the ETA may be determined (340), and the weight may be applied to the traffic information based on Equation 1.

(ETA-actual travel time)/ETA*100% <Equation 1>

Here, as an example, when (ETA-actual travel time) is equal to or less than 2 minutes, the weight may be set not to be applied to the traffic information. In this connection, the weight is applied to, when the (ETA-actual travel time) is positive, lower the value of the traffic information by the corresponding % and to, when the (ETA-actual travel time) is negative, increase the value of the traffic information by the corresponding % to generate the traffic information. As an example, when the vehicle arrives at the destination earlier than the ETA, the value is lowered by the corresponding % to generate the traffic information (350). In one example, when the vehicle arrives later than the ETA, the value is increased by the corresponding % to generate the traffic information (360).

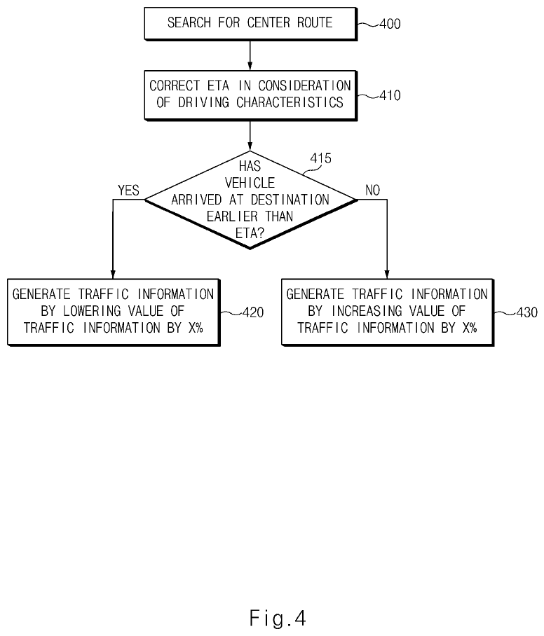

FIG. 4 is a diagram illustrating an operation of providing an ETA for each individual by determining driver characteristics based on an ETA and correcting an estimated time of arrival calculated with general traffic information, according to an embodiment of the present disclosure.

Referring to FIG. 4, when searching for the center route (400), the ETA correction may be performed in consideration of the driving characteristics. In this connection, the driving characteristics includes storing an individual correction history. When the number of individual correcting histories is equal to or more than N, as an example, statistical processing (arithmetic mean and the like) is performed for 5 cases to calculate an individual correction factor(x), and the individual correction factor(x) is updated in units of N cases. However, an update period is N cases and the statistical processing refers to all correction values. Accordingly, after the route search, display of an ETA corrected using the individual correction factor is performed after receiving the estimated time of arrival (410).

Thereafter, after arriving at the destination, it may be determined whether the vehicle has arrived at the destination earlier than the ETA corrected using the individual correction factor (415). When the vehicle has arrived at the destination earlier than the ETA corrected using the individual correction factor, the traffic information is generated by lowering the value thereof by x % (420). In one example, when the vehicle has arrived at the destination later than the ETA corrected using the individual correction factor, the traffic information is generated by increasing the value thereof by x % (430).

That is, more specialized traffic information may be generated by generating the traffic information by reflecting the individual driving characteristics. Thus, the driving characteristics may be determined as the time of arrival and applied to the traffic information reflecting the correction factor. Accordingly, the estimated time of arrival specialized by reflecting the individual driving characteristics may be provided. In consideration of the individual characteristics, the estimated time of arrival may be corrected and provided.

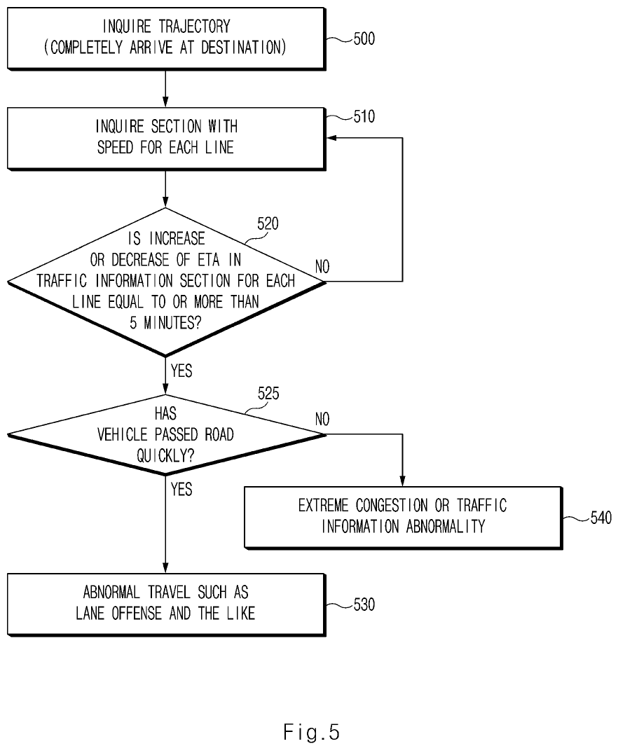

FIG. 5 is a diagram illustrating logic for recognizing a corresponding situation and taking action by a server using trajectory information in addition to being filtered for each individual, according to an embodiment of the present disclosure.

Referring to FIG. 5, after completely arriving at the destination, the vehicle performs a trajectory inquiry by performing a center route search service (500). In this connection, a section with a speed for each line is inquired (510), and an estimated passing time of a center for each section and an actual trajectory passing time are compared with each other (520).

In this connection, when a difference in the traffic information for each line is equal to or more than 5 minutes, it is determined whether it is a case in which the vehicle passes the corresponding section quickly (525). In this connection, when the vehicle passes the corresponding section quickly with a difference equal to or more than 5 minutes, it is determined that there is a high possibility that the travel of the vehicle is the abnormal travel such as the lane offense and the like (530). In one example, when it is determined to be a case in which the vehicle passes the corresponding section slowly rather than passing the corresponding section quickly with a difference equal to or more than 5 minutes (540), it is determined that an extreme congestion has occurred in the corresponding section or that the abnormality has occurred in the traffic information (540).

The subsequent processing for the traffic information therefor is possible. The filtering is performed in the case of the abnormal travel after identifying another probe for the case of passing the corresponding section quickly. Alternatively, in the case of the normal travel after the identification of another probe, the traffic information of the corresponding section is corrected. In one example, in the case of the abnormal travel, the filtering is performed after the identification of another probe for the case of passing the corresponding section slowly. In the case of the normal travel after the identification of another probe, the traffic information of the corresponding section is corrected. Therefore, in the present disclosure, when a difference between the ETA and the travel speed more than a predetermined time for each corresponding section occurs, another probe may be identified to correct the probe that generates the error in the traffic information.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The present technology, which collects traffic information and calculates the estimated time of arrival, is intended to provide a method for comparing the estimated time of arrival calculated using the general traffic information with the actual time of arrival of each vehicle to infer the driving habit of the driver, and correcting the traffic information generated from the corresponding vehicle to generate the more accurate traffic information. Therefore, the present technology is intended to provide an advantage of generating and providing more general traffic information through correction of a vehicle that causes an error at the same time as the filtering of the vehicle acting as the noise when collecting the traffic information. In addition, the present technology is intended to provide an advantage of providing the estimated time of arrival (ETA) specialized for each individual.

In addition, various effects that are directly or indirectly identified through the present document may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for controlling traveling of a vehicle, the method comprising:
storing an estimated time of arrival (ETA) provided when searching for a center route;
storing a time of arrival when arriving at a destination;
comparing the estimated time of arrival with the time of arrival;
performing correction on traffic information in consideration of the comparison result; and
providing an estimated time of arrival (ETA) specialized for each driver.

2. The method of claim 1, wherein performing the correction on the traffic information includes:
determining whether there is an increase or decrease of the ETA in a traffic information section for each line equal to or more than a predetermined reference time.

3. The method of claim 1, wherein performing the correction on the traffic information includes:
comparing the provided ETA with the time of arrival to determine whether a driver of the vehicle has a travel speed higher than or lower than a travel speed of another driver.

4. The method of claim 3, wherein performing the correction on the traffic information includes:
filtering the corresponding traffic information in consideration of determining whether the driver of the vehicle has the travel speed higher than or lower than the travel speed of another driver.

5. The method of claim 4, wherein filtering the traffic information includes:
excluding abnormal travel of the driver, or identifying and excluding abnormality in the traffic information not accurately reflected even though a corresponding traffic information section is actually congested.

6. The method of claim 3, wherein performing the correction on the traffic information includes:
comparing the provided ETA with the time of arrival, and applying a weight to the traffic information.

7. The method of claim 5, wherein performing the correction on the traffic information includes:
comparing the ETA with an actual travel time, and determining whether a difference between the ETA and the actual travel time is within a predetermined time range.

8. The method of claim 7, wherein performing the correction on the traffic information includes:
applying, when (ETA-actual travel time) is positive, a weight to the traffic information to lower a value of the traffic information by a corresponding %; and
applying, when the (ETA-actual travel time) is negative, the weight to the traffic information to increase the value of the traffic information by a corresponding %.

9. The method of claim 1, wherein providing the estimated time of arrival (ETA) specialized for each driver includes:
storing an individual correction history for each driver.

10. The method of claim 9, wherein providing the estimated time of arrival (ETA) specialized for each driver includes:
determining whether a number of individual correction histories exceeds a predetermined number of times N;
calculating an individual correction factor(x) for the number of times;
updating the individual correction factor(x) in units of N cases; and
providing a corrected ETA using the updated individual correction factor.

11. A device for controlling traveling of a vehicle, the device comprising:
an antenna for receiving a global positioning system (GPS) signal;
a processor configured to identify the signal received through the antenna to calculate coordinates of a location and a speed of the vehicle; and
a display device configured to provide the calculated result,
wherein the processor is configured to:
store an estimated time of arrival (ETA) provided when searching for a center route;
store a time of arrival when arriving at a destination;
compare the estimated time of arrival with the time of arrival;
perform correction on traffic information in consideration of the comparison result; and
provide an estimated time of arrival (ETA) specialized for each driver.

12. The device of claim 11, wherein the processor is configured to determine whether there is an increase or decrease of the ETA in a traffic information section for each line equal to or more than a predetermined reference time.

13. The device of claim 11, wherein the processor is configured to compare the provided ETA with the time of arrival to determine whether a driver of the vehicle has a travel speed higher than or lower than a travel speed of another driver.

14. The device of claim 13, wherein the processor is configured to determine whether to filter the traffic information in consideration of the determination of whether the driver of the vehicle has the travel speed higher than or lower than the travel speed of another driver.

15. The device of claim 14, wherein the processor is configured to exclude abnormal travel of the driver, or identify and filter abnormality in the traffic information not accurately reflected even though a corresponding traffic information section is actually congested.

16. The device of claim 13, wherein the processor is configured to compare the provided ETA with the time of arrival, and apply a weight to the traffic information.

17. The device of claim 15, wherein the processor is configured to compare the ETA with an actual travel time, and determine whether a difference between the ETA and the actual travel time is within a predetermined time range.

18. The device of claim 17, wherein the processor is configured to:
apply, when (ETA-actual travel time) is positive, a weight to the traffic information to lower a value of the traffic information by a corresponding %; and
apply, when the (ETA-actual travel time) is negative, the weight to the traffic information to increase the value of the traffic information by a corresponding %.

19. The device of claim 11, wherein the processor is configured to control to store an individual correction history for each driver in storage.

20. The device of claim 19, wherein the processor is configured to:
determine whether the number of individual correction histories exceeds a predetermined number of times N;
calculate an individual correction factor(x) for the number of times;
update the individual correction factor(x) in units of N cases; and
perform calculation to provide a corrected ETA using the updated individual correction factor.
